(19) United States
(12) Patent Application Publication
(10) Pub. No.: US 2008/0210069 A1
(43) Pub. Date: Sep. 4, 2008

(54) EVEN-ENDING DEVICE FOR PROCESSING EQUIPMENT

(75) Inventor: Edward W. Ritola, LaCenter, WA (US)

Correspondence Address: SCHWABE, WILLIAMSON & WYATT, P.C.;PACWEST CENTER, SUITE 1900, 1211 SW FIFTH AVENUE, PORTLAND, OR, 97204, US

(73) Assignee: U.S. Natural Resources, Inc., Woodland, WA (US)

(21) Appl. No.: 12/039,105

(22) Filed: Feb. 28, 2008

Related U.S. Application Data
(63) Continuation of application No. 60/892,758, filed on Mar. 2, 2007.

(30) Foreign Application Priority Data
Mar. 6, 2007 (CA) 2580898

(51) Int. Cl. B26D 5/02; B23Q 15/00

(52) U.S. Cl. 83/75.5; 144/357

(57) ABSTRACT

An even ending device is disclosed that is adapted to even end lumber and other materials being conveyed in a longitudinal end to end fashion. Embodiments include a mover adapted to work with a material support, and engage each piece of material to urge the end of the material towards a fence to form an even end line. Various embodiments also may include fixed, live, and/or moving solid fence, as well as powered and no-powered movers.

### TECHNICAL FIELD

Embodiments of the invention pertain to methods for even ending material such as lumber, and in particular to more accurately even ending the material to reduce waste and inconsistencies.

### BACKGROUND

The lumber processing industry has evolved over the years such that it is becoming more and more efficient to process lumber faster and more accurately. In one particular part of a process known as end trimming, boards having somewhat unequal lengths are moved longitudinally on rolls to a moving bumper or fence and laterally on conveyor chains through saws such that they can be accurately cut to length.

In sawmills, particularly high speed sawmills, there has been a problem with even ending lumber to a common even-end line. In some applications the lumber has to be very accurately positioned. In a precision-end trimmer (PET), for example, the lumber is cut to a very tight tolerance. In such systems, the lumber is moved longitudinally on rolls to a moving bumper or fence and laterally on conveyor chains through saws to accurately cut them to length. It has been a problem to positively move the boards to the end bumper and keep them at the bumper or fence in the distance allowed without bouncing back. If the saw at the even end is very close to the bumper longitudinally, the saw may not cut the end of the board if it hasn't reached the bumper or has bounced away from the bumper.

The issue with getting the board to abut the end bumper is compounded in situations where a batch of boards is being moved together in an edge to edge fashion. When even-ending lumber that is edge to edge, the side friction of the boards causes the lumber to resist moving up to the bumper or fence. Where a board is not properly lined up, and the edges are trimmed, the resulting board will not be cut to the proper length and may need to be further processed or scrapped altogether.

### DRAWINGS

Embodiments of the present invention will be readily understood by the written description along with reference to the accompanying renderings. Embodiments of the invention are illustrated by way of example and not by way of limitation in the accompanying figures.

FIG. 1 illustrates a top view of an even ending device in accordance with various embodiments of the present invention;

FIG. 2 illustrates an end view of an even ending device in accordance with various embodiments of the present invention;

FIG. 3 illustrates a side view of an even ending device in accordance with various embodiments of the present invention;

FIG. 4 illustrates a top view of an even ending device in accordance with various embodiments of the present invention; and

FIG. 5 illustrates a top view of an even ending device in accordance with various embodiments of the present invention.

### DETAILED DESCRIPTION OF EMBODIMENTS OF THE INVENTION

In the following detailed description, reference is made to the accompanying drawings which form a part hereof wherein like numerals if illustrated designate like parts throughout, and in which is shown by way of illustration embodiments in which the invention may be practiced. It is to be understood that other embodiments may be utilized and structural or logical changes may be made without departing from the scope of the present invention. Therefore, the following detailed description is not to be taken in a limiting sense, and the scope of embodiments in accordance with the present invention is defined by the appended claims and their equivalents.

Various operations may be described as multiple discrete operations in turn, in a manner that may be helpful in understanding embodiments of the present invention; however, the order of description should not be construed to imply that these operations are order dependent.

The description may use perspective-based descriptions such as up/down, back/front, and top/bottom. Such descriptions are merely used to facilitate the discussion and are not intended to restrict the application of embodiments of the present invention.

For the purposes of the present invention, the phrase “A/B” means A or B. For the purposes of the present invention, the phrase “A and/or B” means “(A), (B), or (A and B).” For the purposes of the present invention, the phrase “at least one of A, B, and C” means “(A), (B), (C), (A and B), (A and C), (B and C), or (A, B and C).” For the purposes of the present invention, the phrase “(A)B” means “(B) or (AB)”, that is, A is an optional element.

The terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still cooperate or interact with each other.

The description may use the phrases “in an embodiment,” or “in embodiments,” which may each refer to one or more of the same or different embodiments. Furthermore, the terms “comprising,” “including,” “having,” and the like, as used with respect to embodiments of the present invention, are synonymous.

Embodiments of the present invention may include methods for evening ending materials, such as lumber, being processed individually or in batches. In various embodiments, boards may be moved against a bumper, fence, or other edge aligning member (herein referred to generally as a fence) to confirm that the ends are generally even prior to an end sawing process. Various embodiments may be accomplished by using an independent mover adapted to engage a surface of the board and force the board or other material against the fence.

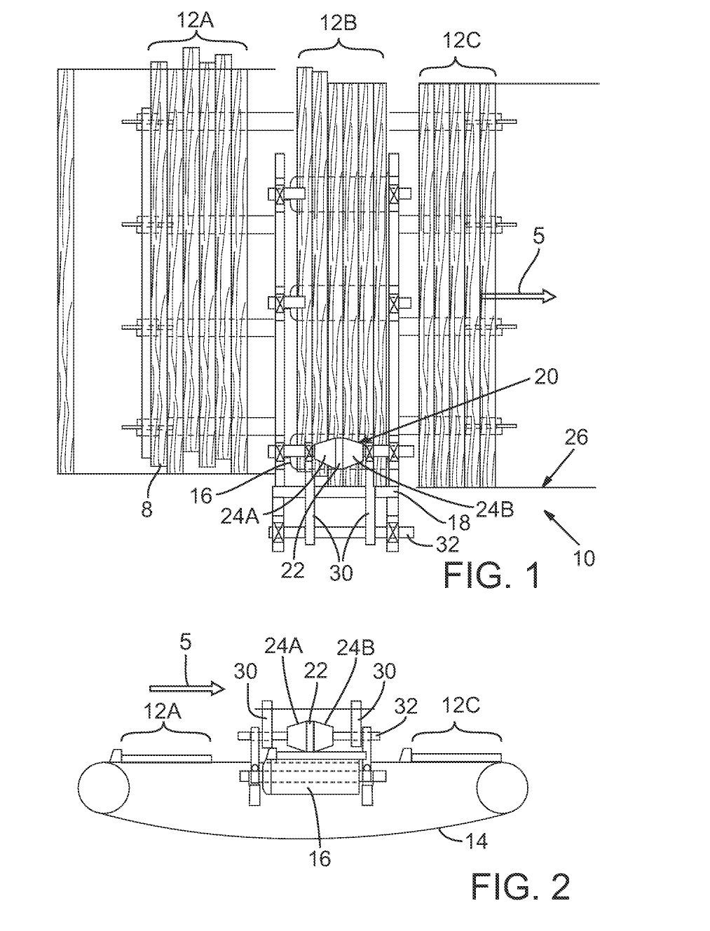

FIG. 1 illustrates a top view and FIG. 2 illustrates an end view of an even ending device in accordance with embodiments of the present invention. In one embodiment, even ending device 10 may be adapted to process one or more pieces of material 8 (illustrated as boards) aligned in an edge to edge relationship. Incoming batch 12A includes multiple boards having side edges aligned, but having ends that may not be generally aligned. A lug conveyor 14 or other material conveyor may move board batch 12 through the even ending device 10 in a direction generally transverse to the longitudinal boards making up the batch 12, as indicated by arrow 5. As the batch 12 moves into the even ending portion of the device (illustrated as batch 12B), one or more under rollers 16 may be adapted to urge the boards towards a fence 18 to even up at least one end of the batch. As a result of side pressure and edge friction, among other competing forces, the boards may not all generally align against the fence 18.

To help ensure better alignment, an overhead mover 20 may be used to apply pressure to the board's upper surface such that it may work in conjunction with the under roller 16 or other support to force the board ends to the fence as they pass the mover 20. Further by virtue of the engagement by the mover 20, the board may resist the bounce back effect. In various embodiments, the overhead mover may be a roller adapted to apply pressure to or squeeze the board against a powered under roll/mover, such that the board may overcome the various competing forces and move the end of the board toward the fence.

In various embodiments, and as illustrated, the overhead mover may be roller configured such that it can engage a single board at a time, at least for a moment, in order to help that board overcome the forces acting upon it by adjacent pieces that may otherwise prevent the board from moving towards the fence. In one embodiment, the engaging face 22 of the mover 20 may be narrower than the width of the boards being processed, such that when a board passes by the mover (or visa versa) the board may get individual treatment so each board may be driven to the bumper and not allowed to bounce back. In various embodiments, the mover may be a roller having tapered infeed and outfeed ends 24A and 24B. Such tapers may aid in the transition of the engaging face 22 from board to board. In such a configuration, as the mover passes relative to the side by side boards of batch 12B, the mover may move across the boards without creating undue skewing forces. Further, coupled with a vertically movable mover, boards of differing thicknesses may be accommodated in the same batch.

As the boards pass, they are moved to a position where the ends of the batch 12 share a common edge 26, as illustrated by batch 12C. Once even ended, the ends may be trimmed as desired.

In various embodiments, the mover 20 may be a roller as shown and described above. In other embodiments, the mover may be a lug, conveyor or other device that can interface with a surface of the boards on an individual basis as they pass, such that they may be moved toward the fence for even ending purposes. Further, though the mover is illustrated as being positioned above the material and engaging an upper surface, in various embodiments the mover may be positioned below the material being even ended, and adapted to engage a bottom surface of the board. In various embodiments, the mover may be adapted to have a friction enhancing surface that is adapted to engage the surface of the boards. This may help better overcome the potential resisting forces cased by, for example, edge friction.

In various embodiments, the mover may be variably and controllably adjustable in several direction directions. For example, the height of the mover may be raised and lowered depending on the thickness of a board that is being engaged. In one embodiment, as illustrated in FIG. 1, the mover may be coupled by support arms 30, which are pivotally coupled to a mount 32. Yet in other embodiments, the width of the mover may be altered in order to accommodate the width of the boards being processed. Again, other dimensions may be altered in order to accommodate the material being processed. In various embodiments, the mover may be adapted to engage any surface of the board and be positioned relative to the surface to be engaged.

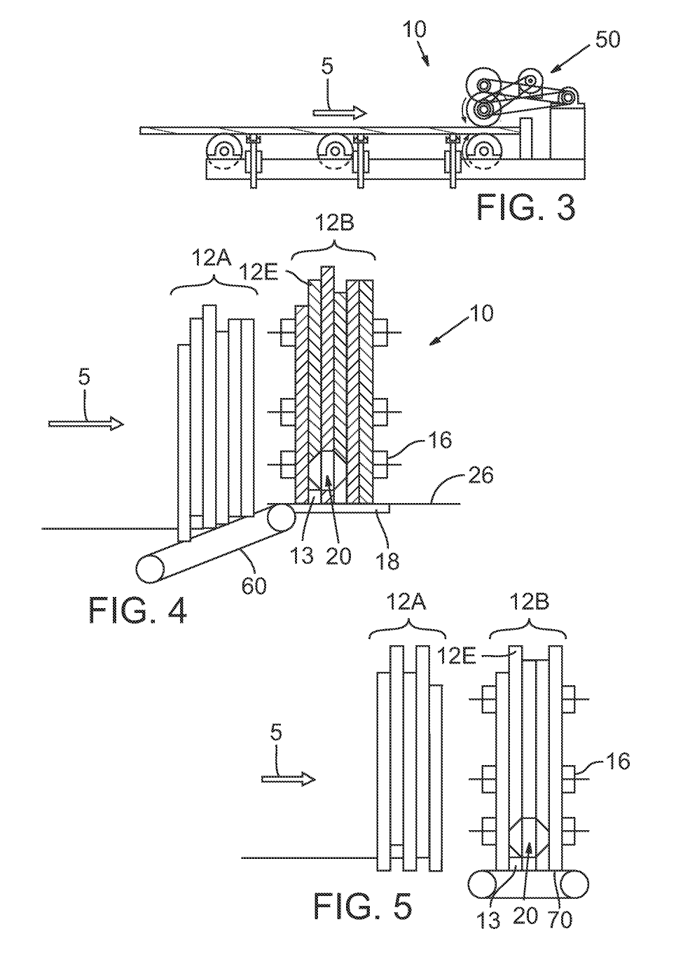

FIG. 3 illustrates a side view of an even ending device in accordance with various embodiments of the present invention. Even ending Device 10 may include a powered mover 50, which may work in conjunction with the lower support that engages the under side of the boards (e.g. under rollers 16). The powered mover 50 may better urge movement of the individual boards towards the fence. Though the under rollers 16 are illustrated (similar to FIG. 1), a powered mover may better allow for the use of lower supporting surfaces which may or may not be adapted to urge the boards towards the fence, such as a flat conveyor, chain or lug conveyor or smooth generally solid surface. The mover 50 may be powered by any one of a number of conventional means, including, but not limited to chain and sprocket or belt and pulley arrangements that are driven by a motor.

As described with various embodiments, the mover, in conjunction with the material support and/or under roller, work to urge boards to a fence for even ending and resist the bounce back effect. Fixed fences may also be used, for example, when the outgoing even end is outside of the incoming ends of the boards (staggered or not), which may often be referred to as the incoming lumber line. In a lumber line, the ends of the boards may be plus and minus of the lumber line (i.e. staggered). Where the ends of the boards or lumber line are outside or past the even end line, a live fence may be used in order to urge the ends/lumber line back towards the even end line.

FIG. 4 illustrates a top view of an even ending device in accordance with various embodiments of the present invention. Even ending device 10 may include a live fence 60, positioned at an angle with respect to the even end line 26. As the boards are conveyed through the device 10, the edges of the boards 12A that are past the even end line 26 engage the live fence 60 and are urged longitudinally back towards the even end line 26. Because edge friction and various other forces may causes some boards to be pushed too far inwards past the even end line (e.g. board 12E) thus leaving a gap 13 between the edge of board 12E and the fence, the mover 20 may then help move the individual board ends back to the fence 18, which may be fixed or live, for even ending

As there may be edge friction between the edges of the boards, there may also be edge friction between the ends of the boards being even ended and the fence, particularly where the fence is a fixed fence. In various embodiments, a live fence having the same plane as the desired even end line may be used to reduce the potential for end/fence friction which may again result in undesired skewing effects.

FIG. 5 illustrates a top view of an even end device in accordance with various embodiments. Even end device 10 may be adapted to even end incoming board batch 12A having staggered ends that are generally inside the even end line 26. Even end device 10 may include one or more under rollers 16 as a material support, and a mover 20 adapted to engage surfaces of the boards of batch 12B individually in order to urge the non-even ended boards to the fence 70. To reduce the friction between the ends of the boards of batch 12A and the fence 70, as well as other forces that may tend to cause undesirable effects such as skewing, fence 70 may be a live fence adapted to move or revolve in the direction of travel 5. In various embodiments, the speed to which the live fence 70 moves may be generally the same as the speed that the lumber batches move through the device 10. This may reduce or even eliminate the frictional forces that may come into play if the ends of the boards were sliding along a fixed fence, for example.

Live fences used in accordance with various embodiments may be any one of a variety of moving fences, such as conveyors, chains, etc. In various embodiments, the rate of rotation of the live fence may be substantially the same as the rate of the boards moving through the device 10, which again may help prevent a skewing effect. Further, angled live fences, as illustrated in FIG. 4 and horizontal (fences co-planar with the even end line) as illustrated in FIG. 5 may be used separately or together. In various embodiments, the live fences may be adapted to move via a number of mechanisms as discussed above. Further, the speed of the live fence may be modified/controlled to further reduce friction, skewing or other tendencies.

Finally, in various embodiments (though not illustrated), a moving solid fence may be used to assist in the even ending of lumber or to move the ends of the incoming batches that are past or outside the even end line to the even end line. Such moving solid fences may be adapted to move towards and away from the board ends to enhance the even ending process. In various embodiments, such moving solid fences may generally be parallel to the even end line and be adapted to move towards the even end line. In various other embodiments, the moving solid fence may be positioned at an angle with respect to the even end line and be adapted to move between an angular, parallel and coplanar position with the even end line as needed to move the ends of the lumber to the even end line. Such moving solid fences may be used in conjunction with other fixed or live fences as well as a mover in accordance with various embodiments.

Devices in accordance with various embodiments may be used in conjunction with not only end trimmers, but also with other material and/or lumber processing equipment where a relatively accurate incoming end line is desired.

In various other embodiments, the mover may be individual, or multiple movers may be positioned such that they can cover a larger area which maybe necessitated by a larger batch of boards. In some embodiments, the mover may be adapted to move across the boards, the mover may be relatively stationary and the board move relative to the mover, and/or both the boards and the mover may move.

A variety of factors may affect the number and other characteristics of the mover in order to achieve the even ending process. Such factors may include, but are not limited to the distance the board has to move in a particular direction (e.g. longitudinally), the width of the boards, the transverse speed of the conveyor and the width of the face of the mover. Accordingly, in various embodiments one or more movers may be used and dynamically controlled to accommodate for the various factors. For example, fewer (e.g. one) movers may be needed where the amount of board ending required is less/shorter, the boards are wider, the transverse speed of the conveyor is slower, and/or the configuration of the mover is narrower.

While embodiments have been described with respect to lumber processing equipment, and in particular end trimmers, embodiments may be used with a variety of machines where an even end line is important. Further, such embodiments may be used where the material being processed is something other than lumber.

Although certain embodiments have been illustrated and described herein for purposes of description of the preferred embodiment, it will be appreciated by those of ordinary skill in the art that a wide variety of alternate and/or equivalent embodiments or implementations calculated to achieve the same purposes may be substituted for the embodiments shown and described without departing from the scope of the present invention. Those with skill in the art will readily appreciate that embodiments in accordance with the present invention may be implemented in a very wide variety of ways. This application is intended to cover any adaptations or variations of the embodiments discussed herein. Therefore, it is manifestly intended that embodiments in accordance with the present invention be limited only by the claims and the equivalents thereof.

1. A material even ending device, comprising:
A material support adapted to support a first surface of one or more longitudinal pieces of material having a first end in relation to a fence; and
A mover adapted to engage a second and generally opposite surface of the material and work in conjunction with the material support to move the one or more longitudinal pieces of material towards the fence and urge engagement of the first end with the fence to establish an even end line.

2. The material even ending device of claim 1, wherein the material support engages the surfaces of two or more of the longitudinal pieces of material at the same time; and
wherein the mover is sized to engage the second surface of the pieces of material individually.

3. The material even ending device of claim 2, wherein the material support includes one or more powered rollers adapted to span the width of two or more pieces of material.

4. The material even ending device of claim 1, wherein mover is a roller having a width that is less than or equal to the width of any one of the pieces of material.

5. The material even ending device of claim 1, wherein the mover is a roller having a surface engaging portion, a first tapered infeed end and a second tapered outfeed end.

6. The material even ending device of claim 1,wherein the mover is powered to help urge the individual pieces of material to the fence.

7. The material even ending device of claim 1, wherein the mover is mounted to allow the mover to move vertically in order to accommodate different thicknesses of the one or more longitudinal pieces of material.

8. The material even ending device of claim 1, wherein the pieces of material are conveyed past the mover in batches of two or more boards aligned in an edge to edge relationship.

9. The material even ending device of claim 1, wherein the fence is movable in relation to ends of the material pieces.

10. The material even ending device of claim 1, wherein the fence is a live fence.

11. The material even ending device of claim 10, wherein the live fence is positioned at an angle with respect to the even end line.

12. The material even ending device of claim 10, wherein the live fence is generally co-planar with the even end line.

13. A method of even ending longitudinal pieces of material, comprising:
conveying two or more pieces of material in a first direction generally transverse to a longitudinal centerline of the pieces along a support surface adapted to engage a first side of the material;
engaging an opposite second side of the material with a mover;
moving one or more of the longitudinal pieces of material in a direction parallel with the longitudinal centerline towards a fence, wherein the mover and the support surface cooperate to move the one or more longitudinal pieces towards the fence.

14. The method of claim 13, wherein the conveying two or more pieces along a support surface, includes providing a support surface that includes a powered roller that moves pieces towards the fence.

15. The method of claim 13, wherein the engaging an opposite second side of the material with a mover includes
providing a powered overhead roller adapted to engage a single piece at a time; and
moving the one piece towards the fence.
